(19) United States
(12) Patent Application Publication
(10) Pub. No.: US 2017/0078957 A1
(43) Pub. Date: Mar. 16, 2017

(54) METHOD AND APPARATUS FOR DETERMINING IMS CONNECTIVITY THROUGH NON-3GPP ACCESS NETWORKS

(71) Applicant: Nokia Technologies Oy, Espoo (FI)

(72) Inventors: Jari Kalevi Mutikainen, Lepsama (FI); Sami Kekki, Helsinki (FI)

(21) Appl. No.: 15/123,493

(22) PCT Filed: Mar. 6, 2014
(86) PCT No.: PCT/IB2014/059504

§ 371 Date: Sep. 2, 2016

(51) Int. Cl. H04W 48/18; H04L 29/06; H04W 48/08; H04W 8/02

(52) U.S. Cl. CPC H04W 48/18; H04W 8/02; H04L 65/1016; H04W 48/08; H04W 84/042

(57) ABSTRACT

A method, apparatus and computer program product are provided for determining IMS connectivity through non-3GPP access networks. A method is provided for receiving, in response to an access network query, an available public land mobile network (PLMN) list; wherein the PLMN list comprises an IP multimedia subsystem access point name (IMS APN) indication for the respective PLMNs with IMS connectivity; determining, using a processor, if a connection to a home PLMN (HPLMN) can be established using an IMS APN associated with a PLMN from the PLMN list; and prioritizing available wireless local area networks (WLAN) based on the determining if a connection to the HPLMN can be established using the IMS APN for the respective PLMNs of the PLMN list associated with the respective WLANs.

### TECHNOLOGICAL FIELD

An example embodiment of the present invention relates IMS connectivity determinations and, more particularly, internet protocol multimedia subsystem (IMS) connectivity determinations through non-3GPP (3rd generation partnership project) access networks.

### BACKGROUND

Current wireless local area network (WLAN) selection procedures do not include the information needed by a user equipment (UE) to determine IMS connectivity availability through available WLANs. For example, 3GPP TS 23.402 does not provide a UE with the information regarding IMS connectivity prior to selection of a WLAN network and establishment of a packet data network (PDN) connection. To obtain the information the UE may attempt to authenticate the WLAN network and attempt to establish the IMS PDN connection, e.g. to an IMS APN. The UE then could determine if the PDN connection was successful and established in a local break-out (LBO) manner. LBO as defined in 22278-Service Requirements for the Evolved Packet System (EPS) may refer to an instance in which the UE 10 is served by the VPLMN 14, the information traffic does not leave the current region, e.g. the information traffic is not routed through the HPLMN. The inefficiency of this process is increased for each additional WLAN available. Such a trial and error approach renders the WLAN selection process that is based on the use of WLAN Selection Policy (WLANSP) unusable for establishing a connection to a WLAN with IMS connectivity, since the purpose of the WLANSP is to avoid a trial and error approach.

Recent advancements in the WLAN selection process includes S2a connectivity, allowing the UE to determine public land mobile networks, if any, which a WLAN supports, but have not addressed IMS connectivity.

In order to establish evolved packet core (EPC) connectivity for IMS service, the UE needs certain information prior to selecting a WLAN network to connect to. For example, the UE may need to determine if a visited PLMN (VPLMN) to which the WLAN is connected supports IMS access point name (APN) in a LBO manner, and whether the VPLMN provides connectivity for IMS roaming to a home network or home PLMN (HPLMN). If the UE does not have the information to make this determination, the UE may select a WLAN network that does not support IMS level roaming connection to the HPLMN. In some instances, although the selected network does not support IMS level roaming connection to the HPLMN, it may support roaming to a HPLMN via an S2a, or similar interface. In an instance in which another WLAN access network is available with IMS level roaming connection to the HPLMN, the selected VPLMN is less optimal.

When a UE activates a selected WLAN, it typically disables packet data through 3GPP at the same time, therefore, voice service may be limited to circuit switched (CS) network if the selected WLAN does not support IMS connectivity. This results in IMS video service not being available to the UE. Further, a user may prefer to use IMS services instead of a CS network, when available, which also would not be available.

### BRIEF SUMMARY

A method, apparatus and computer program product are provided in accordance with an example embodiment in order to facilitate determining IMS connectivity through non-3GPP access networks. In an example embodiment, a method is provided that includes receiving, in response to an access network query, an available public land mobile network (PLMN) list; wherein the PLMN list comprises an IP multimedia subsystem access point name (IMS APN) indication for the respective PLMNs with IMS connectivity; determining, using a processor, if a connection to a home PLMN (HPLMN) can be established using an IMS APN associated with a PLMN from the PLMN list; and prioritizing available wireless local area networks (WLAN) based on the determining if a connection to the HPLMN can be established using the IMS APN for the respective PLMNs of the PLMN list associated with the respective WLANs.

The method of an example embodiment may also include filtering the PLMN list based on PLMNs which can establish communication with the HPLMN using the associated IMS APN. In an example embodiment of the method, the PLMN list also includes IMS APN availability information for the respective PLMNs In that regard, the PLMN list also includes an IMS roaming level indication for the respective IMS APNs. In another example embodiment of the method, the PLMN list includes an APN information code for the respective PLMNs, wherein the APN information code identifies the available service APNs. In an example embodiment of the method, the PLMN list further comprises PLMNs that interwork on IMS level with the respective PLMNs. In an example embodiment of the method, the IMS connectivity is local break out roaming.

In another example embodiment, an apparatus is provided that includes at least one processor and at least one memory including computer program code with the memory and computer program code configured to, with the processor, cause the apparatus to receive, in response to an access network query, an available public land mobile network (PLMN) list; wherein the PLMN list comprises an IP Multimedia Subsystem access point name (IMS APN) indication for the respective PLMNs with IMS connectivity; determine, using a processor, if a connection to a home PLMN (HPLMN) can be established using an IMS APN associated with a PLMN from the PLMN list; and prioritize available wireless local area networks (WLAN) based on the determining if a connection to the HPLMN can be established using the IMS APN for the respective PLMNs of the PLMN list associated with the respective WLANs.

The at least one memory and computer program code may be further configured to, with the processor, cause the apparatus of an example embodiment to filter the PLMN list based on PLMNs which can establish communication with the HPLMN using the associated IMS APN. In an example embodiment of the apparatus, the PLMN list also includes IMS APN availability information for the respective PLMNs. In that regard, the PLMN list also includes an IMS roaming level indication for the respective IMS APNs. In an example embodiment of the apparatus, the PLMN list also includes an APN information code for the respective PLMNs, wherein the APN information code identifies the available service APNs. In an example embodiment of the apparatus, the PLMN list further comprises the PLMNs that interwork on IMS level with the respective PLMNs. In the apparatus of an example embodiment, the IMS connectivity is local break out roaming.

In a further embodiment, a computer program product is provided that includes at least one non-transitory computer readable medium having program code portions stored thereon with the program code portions configured, upon execution, to receive, in response to an access network query, an available public land mobile network (PLMN) list; wherein the PLMN list comprises an IP Multimedia Subsystem access point name (IMS APN) indication for the respective PLMNs with IMS connectivity; determine, using a processor, if a connection to a home PLMN (HPLMN) can be established using an IMS APN associated with a PLMN from the PLMN list; and prioritize available wireless local area networks (WLAN) based on the determining if a connection to the HPLMN can be established using the IMS APN for the respective PLMNs of the PLMN list associated with the respective WLANs.

The computer-executable program code portions of an example embodiment may also include program code instructions configured to filter the PLMN list based on PLMNs which can establish communication with the HPLMN using the associated IMS APN. In an example embodiment of the computer program product, the PLMN list also includes IMS APN availability information for the respective PLMN. In that regard, the PLMN list also includes an IMS roaming level indication for the respective IMS APNs. In an example embodiment of the computer program product, the PLMN list also includes an APN information code for the respective PLMNs, wherein the APN information code identifies the available service APNs. In an example embodiment of the computer program product, the PLMN list further comprises the PLMNs that interwork on IMS level with the respective PLMNs.

In yet another example embodiment, an apparatus is provided that includes means for receiving, in response to an access network query, an available public land mobile network (PLMN) list; wherein the PLMN list comprises an IP multimedia subsystem access point name (IMS APN) indication for the respective PLMNs with IMS connectivity; means for determining, using a processor, if a connection to a home PLMN (HPLMN) can be established using an IMS APN associated with a PLMN from the PLMN list; and means for prioritizing available wireless local area networks (WLAN) based on the determining if a connection to the HPLMN can be established using the IMS APN for the respective PLMNs of the PLMN list associated with the respective WLANs.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network communications diagram in accordance with an example embodiment of the present invention;

FIG. 2 is a block diagram of an apparatus that may be specifically configured for determining IMS connectivity through non-3GPP access networks in accordance with an example embodiment of the present invention; and

FIG. 3 is a flow chart illustrating the operations performed, such as by the apparatus of FIG. 2, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment for determining IMS connectivity through non-3GPP access networks.

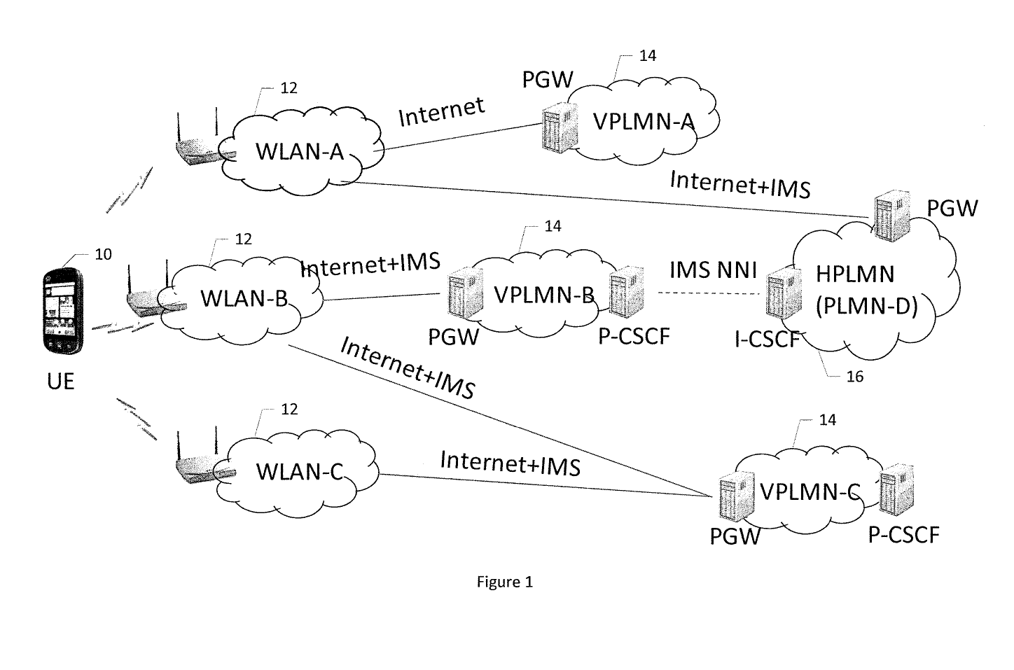

FIG. 1 illustrates a network communication diagram including a UE 10, WLAN A, B, and C 12 in communication with PLMNs A-C 14, and D 16. The UE 10 may receive information about or establish communication with WLAN A, B, or C 12. WLAN-A 12 interworks with PLMN-A 14. That is, the WLAN A 12 has access to a Packet data network Gateway (PGW) in the PLMN-A 14, which is a Visited PLMN for UE 10 (VPLMN). This PGW offers internet service for the UE 10. WLAN-A 12 also interworks with PLMN-D, which is the Home PLMN (HPLMN) for the UE 10. The PGW(s) in PLMN-D offers internet and IMS services for the UE. WLAN-B 12 interworks with PLMN-B 14 and PLMN-C 14, both of which are VPLMNs for the UE 10. Both internet and IMS services are available through WLAN-B 12 through a PGW in PLMNs B and C. PLMN-B 14 also supports IMS network to network interface (NNI) with PLMN-D 16 through a call session control function (CSCF). WLAN-C 12 interworks with PLMN-C 14, which is a VPLMN for the UE 10. PGW(s) in this PLMN offers both internet and IMS service for the UE 10. PLMN-D will herein be referred to as HPLMN 16, which is associated with the UE 10.

The UE 10 may execute an access network query, such as an access network protocol (ANQP) or equivalent protocol, in each of the WLANs A, B and C once the UE has discovered those WLANs. Through ANQP or equivalent protocol the UE receives the information of PLMNs 14/16 which interwork with the given WLAN A, B or C. Furthermore, the UE may receive an indication of the type of interface support from the given WLAN towards these PLMNs connectivity. Examples of types of interface support may include S2a, S2b or S2c interfaces of the evolved packet system (EPS) architecture as described in 3GPP TS23.402 release 12. An example of such a discovery procedure may include IEEE 802.11u. The discovery procedure may be extended to include an IMS connectivity parameter for each of the PLMNs.

In an example embodiment, a PLMN list is received in response to the ANQP query. The PLMN list may include an IMS APN indication for each PLMN 14 of the PLMN list. For example, a PLMN 14 that supports IMS APN may be flagged or otherwise indicates support of IMS APN. Further, the PLMN list may include a list of IMS connected PLMNs 14/16 which are supported by the IMS APN indicated PLMN, which supports IMS roaming in an LBO manner. The indication of IMS roaming refers to the availability of Network to Network Interface (NNI) supporting IMS signaling between the VPLMN 14 and HPLMN 16. The UE 10 may determine if a connection to the HPLMN 16 can be established using an IMS APN. The UE 10 may filter the PLMNs 14/16 based on PLMNs which can establish communication with a HPLMN using an associated IMS APN.

For example, a PLMN list may be received in response to an ANQP query for WLAN-B 12, including PLMN-B 14 and PLMN-C with an IMS APN indication for both. PLMN-B 14 related information may also include HPLMN 16 as a PLMN that interwork on IMS level with PLMN-B 14. A PLMN list in response to an ANQP query for WLAN-C 12 may include PLMN-C 14 with an IMS APN indication, but no IMS connected PLMNs associated with PLMN-C. A PLMN list for an ANQP query for WLAN-A 12 may include PLMN-A 14 without an IMS APN indication, HPLMN 16 with an IMS APN indication, but no IMS connected PLMNs associated with the HPLMN. In an instance in which the UE 10 is configured to connect to an IMS APN in an LBO manner, if available, the UE may search for the HPLMN 16 in the PLMN list. The UE 10 search for the HPLMN 16 may return an available connection to the HPLMN through WLAN-B 12 through PLMN-B 14. In an instance in which the UE 10 is configured to connect to an IMS APN which is not of LBO type, the UE may search the PLMN list PLMNs 14 with IMS APN indications. The search of the PLMNs 14 may return available connections to the HPLMN 16 through WLAN-A 12, connections to PLMN-B and PLMN-C through WLAN-B, and PLMN-C through WLAN-C.

In an example embodiment, the determining if the connection to the HPLMN 16 can be established using an IMS APN is done by the WLAN 12. The UE 10 may send the HPLMN identifier, e.g. mobile country code (MCC) and/or mobile network code (MNC) as a portion of the ANQP query or equivalent protocol procedure, which may be used by the receiving protocol entity, such as a WLAN to filter the PLMNs. In this embodiment, the received PLMN list includes an indication such as true/false for each PLMN indicating if the PLMN supports IMS packet data network (PDN) connection to the HPLMN 16. In another example embodiment, the WLAN 12 may filter out, e.g. not include in the PLMN list based on the ANQP query, PLMNs that do not support IMS PDN connection to the HPLMN 16.

For example, the PLMN list received in response to an ANQP query for WLAN-B 12 may include PLMN-B 14 with the IMS APN indication or flag set to true and PLMN-C with an IMS APN indication set to false. A PLMN list for an ANQP query of WLAN-A 12 may include a PLMN list including HPLMN 16 with an IMS APN indication set to true. A PLMN list for an ANQP query or WLAN-B 12 may include PLMN-B 14 and PLMN-C with an IMS APN indication set to true for both. A PLMN list for an ANQP query of WLAN-C 12 may include PLMN-C 14 with an IMS APN set to true.

In an example embodiment, a PLMN list may be received in response to an ANQP query including all IMS connected PLMNs 14. In an example embodiment, the ANQP query may include a PLMN-ID. In an instance in which the ANQP query includes a PLMN identifier, the PLMN list may be limited to the PLMN 14 which was identified by the PLMN identifier. The PLMN list may include the APNs that are supported by the identified PLMN 14. The PLMN 14 may include an IMS APN indication, which may indicate an IMS level roaming agreement is in place with the HPLMN 16.

For example, a PLMN list received in response to an ANQP query for WLAN-B 12 may include PLMN-B 14. PLMN-B may indicate APNs for internet and IMS, with the IMS APN indication set indicating that an IMS level roaming agreement is in place with HPLMN 16. A PLMN list received in response to an ANQP query for WLAN-A 12 may include PLMN-A 14 and HPLMN 16. PLMN-A may indicate an APN for internet and HPLMN may indicate an APN for IMS, but without the IMS roaming indication. A PLMN list received in response to an ANQP query for WLAN-C may include PLMN-C 14. PLMN-C 14 may indicate APNs for internet and IMS, but without the IMS roaming indication.

In an example embodiment, the response to an ANQP query may include an S2a/b/c connectivity indication PLMN list and a list element or indication for PLMNs 14 that support IMS APN. For each PLMN 14 indicating support of IMS APN, the PLMN list may include a further list or indication for PLMNs that support IMS roaming in an LBO manner.

In an example embodiment, the PLMN list may include an APN information code, such as a bitmask, for each PLMN 14 indicating connectivity options. Each bit in the bitmask corresponds to a certain type of service APN. The bitmask for each PLMN 14 may also specify the availability of an IMS APN and/or other service APNs. The PLMN list bitmasks may also include a list or indication of PLMNs 14 that support IMS level roaming.

The UE 10 may use the IMS APN indication information from each queried WLAN 12 to prioritize the WLANs. For example, the WLANs 12 may be prioritized using 3GPP TS 23.402 release 12 or equivalent procedures. Additionally, in an instance in which the UE 10 is configured to connect to a WLAN 12 which supports IMS connectivity if available, the UE may select the highest priority WLAN which supports IMS connectivity.

In an example embodiment, a user may select or configure the UE 10 to prefer WLAN 12 which supports IMS connectivity in the WLAN selection procedure. In an instance in which the UE 10 is configured with IMS connectivity preferred the UE may select a WLAN 12 as described above. In an instance in which the UE 10 is not configured with IMS connectivity preferred or a WLAN 12 which supports IMS connectivity is not available, the UE may select a WLAN using a prioritization procedure such as 3GPP TS 23.402.

### Example Apparatus

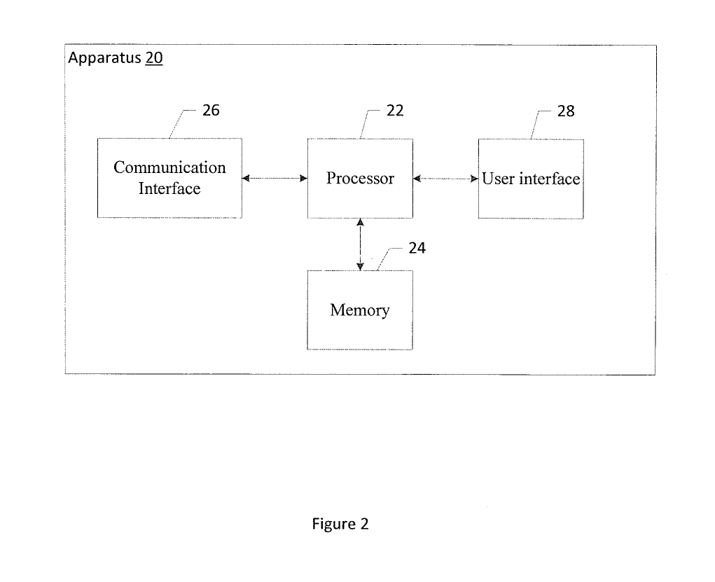

A UE 10 may include or otherwise be associated with an apparatus 20 as shown in FIG. 2. The apparatus, such as that shown in FIG. 2, is specifically configured in accordance with an example embodiment of the present invention to provide for determine IMS connectivity availability through available WLANs. The apparatus may include or otherwise be in communication with a processor 22, a memory device 24, a communication interface 26 and an optional user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by UE 10. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include a communication interface 26 that may be any means such as a device or circuitry embodied in either hardware or a combination of hardware and software that is configured to receive and/or transmit data from/to a communications device in communication with the apparatus, such as to facilitate communications with one or more user equipment 10 or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 20 may also optionally include a user interface 28 that may, in turn, be in communication with the processor 22 to provide output to the user and, in some embodiments, to receive an indication of a user input. As such, the user interface may include a display and, in some embodiments, may also include a keyboard, a mouse, a joystick, a touch screen, touch areas, soft keys, one or more microphones, a plurality of speakers, or other input/output mechanisms. In one embodiment, the processor may comprise user interface circuitry configured to control at least some functions of one or more user interface elements such as a display and, in some embodiments, a plurality of speakers, a ringer, one or more microphones and/or the like. The processor and/or user interface circuitry comprising the processor may be configured to control one or more functions of one or more user interface elements through computer program instructions (e.g., software and/or firmware) stored on a memory accessible to the processor (e.g., memory device 24, and/or the like).

### Example Flowchart for Determining IMS Connectivity through Non-3GPP Access Networks

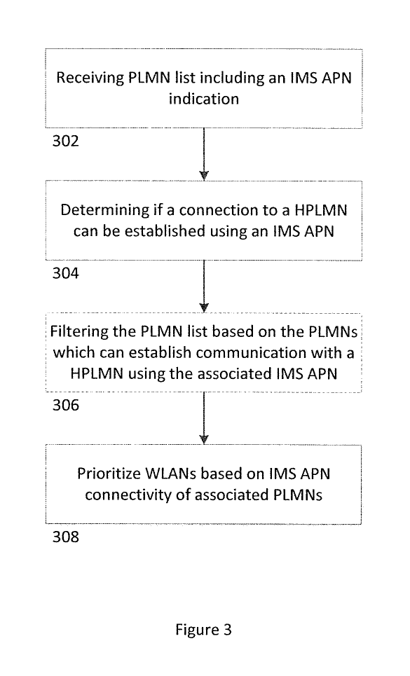

Referring now to FIG. 3, the operations performed, such as by the apparatus 20 of FIG. 2, for determining IMS connectivity through non-3GPP access networks is illustrated. As shown in block 302 of FIG. 3, the apparatus may include means, such as the processor 22, communications interface 26, or the like, configured to receive a PLMN list including an IMS APN indication in response to a access network query. The access network query may be an ANQP or equivalent protocol. The processor 22 may receive the PLMN list from the communications interface 26. The communications interface 26 may receive the PLMN list from a WLAN 12 through wireless communication. In an example embodiment, the PLMN list may include the PLMNs which interwork with the respective WLANs. In addition, the PLMN list may include an IMS APN indication for each PLMN 14 of the PLMN list. For example, a PLMN 14 that supports IMS APN may be flagged or otherwise indicates support of IMS APN. Further, the PLMN list may include a list of IMS connected PLMNs 14/16 which are supported by the IMS APN indicated PLMN, which supports IMS roaming in an LBO manner. For example, a PLMN list may be received in response to an ANQP query for WLAN-B 12, including PLMN-B 14 and PLMN-C with an IMS APN indication for both. PLMN-B 14 related information may include HPLMN 16 as a PLMN that interworks on an IMS level with PLMN-B 14. A PLMN list in response to an ANQP query for WLAN-C 12 may include PLMN-C 14 with an IMS APN indication, but no IMS connected PLMNs associated with PLMN-C. A PLMN list for an ANQP query for WLAN-A 12 may include PLMN-A 14 without an IMS APN indication, HPLMN 16 with an IMS APN indication, but no IMS connected PLMNs associated with the HPLMN.

In an example embodiment, the process 22 may include a HPLMN identifier as a portion of the access network query, e.g. mobile country code (MCC) and/or mobile network code (MNC). In this embodiment, the received PLMN list includes an indication such as true/false for each PLMN indicating if the PLMN supports IMS packet data network (PDN) connection to the HPLMN 16.

For example, the PLMN list received in response to an ANQP query for WLAN-B 12 may include PLMN-B 14 with the IMS APN indication or flag set to true and PLMN-C with an IMS APN indication set to false. A PLMN list for an ANQP query of WLAN-A 12 may include a PLMN list including HPLMN 16 with an IMS APN indication set to true. A PLMN list for an ANQP query or WLAN-B 12 may include PLMN-B 14 and PLMN-C with an IMS APN indication set to true for both. A PLMN list for an ANQP query of WLAN-C 12 may include PLMN-C 14 with an IMS APN set to true.

In an example embodiment, a PLMN list may be received in response to an ANQP query including all IMS connected PLMNs 14. In an example embodiment, the ANQP query may include a PLMN-ID. In an instance in which the ANQP query includes a PLMN identifier, the PLMN list may be limited to the PLMN 14 which was identified by the PLMN identifier. The PLMN list may include the APNs that are supported by the identified PLMN 14. The PLMN 14 may include an IMS APN indication, which may indicate an IMS level roaming agreement is in place with the HPLMN 16.

For example, a PLMN list received in response to an ANQP query for WLAN-B 12 may include PLMN-B 14. PLMN-B may indicate APNs for internet and IMS, with the IMS APN indication set indicating that an IMS level roaming agreement is in place with HPLMN 16. A PLMN list received in response to an ANQP query for WLAN-A 12 may include PLMN-A 14 and HPLMN 16. PLMN-A may indicate an APN for internet and HPLMN may indicate an APN for IMS, but without the IMS roaming indication. A PLMN list received in response to an ANQP query for WLAN-C may include PLMN-C 14. PLMN-C 14 may indicate APNs for internet and IMS, but without the IMS roaming indication.

In an example embodiment, the response to an ANQP query may include an S2a/b/c connectivity indication PLMN list and a list element or indication for PLMNs 14 that support IMS APN. For each PLMN 14 indicating support of IMS APN, the PLMN list may include a further list or indication for PLMNs that support IMS roaming in an LBO manner.

In an example embodiment, the PLMN list may include an APN information code, such as a bitmask, for each PLMN 14 indicating connectivity options. The bitmask for each PLMN 14 may also specify the availability of an IMS APN and/or other service APNs. The PLMN list bitmask may also include a list or indication of PLMNs 14 that support IMS level roaming.

As shown in block 304 of FIG. 3, the apparatus 20 may include means, such as a processor 22, or the like, configured to determine if a connection to the HPLMN 16 can be established using an IMS APN. The processor 22 may use the IMS APN indications of the respective PLMNs of the PLMN list to determine if a connection to the HPLMN 16 can be established.

For example, the processor 22 may determine that a connection to the HPLMN 16 may be established using an IMS APN associated with PLMN-B 14.

In an example embodiment, the WLAN 12 may be configured to determine if a connection to the HPLMN 16 can be established, based on a ANQP query from the apparatus that includes the HPLMN identifier as discussed above in block 302.

In an instance in which the processor 22 is configured to connect to an IMS APN in an LBO manner, if available, the processor may search for the HPLMN 16 in the PLMN list. The processor 22 search for the HPLMN 16 may return an available connection to the HPLMN through WLAN-B 12 through PLMN-B 14. In an instance in which the processor 22 is configured to connect to an IMS APN which is not of LBO type, the UE may search the PLMN list PLMNs 14 with IMS APN indications. The search of the PLMNs 14 may return available connections to the HPLMN 16 through WLAN-A 12, connections to PLMN-B and PLMN-C through WLAN-B, and PLMN-C through WLAN-C.

As shown in block 306 of FIG. 3, the apparatus 20 may include a means, such as a processor 22 or the like, configured to filter the PLMN list based on PLMNs 14 which can establish communication with the HPLMN 16 using an associated IMS APN. The processor 22 may filter the PLMN list based on the determining the PLMNs 14 which can establish communications with the HPLMN 16 as described in block 304.

In an example embodiment, the receiving protocol entity, such as WLAN 12 may be configured to filter out, e.g. not include in the PLMN list based on the ANQP query, PLMNs that do not support IMS PDN connection to the HPLMN 16.

As shown at block 308 of FIG. 3, the apparatus 20 may include means, such as the processor 22, or the like, configured to prioritize the WLANs 12 based on IMS APN connectivity of associated PLMNs. The processor 22 may use the IMS APN indication information from each queried WLAN 12 to prioritize the WLANs. For example, the WLANs 12 may be prioritized using 3GPP TS 23.402 release 12 or equivalent procedures. Additionally or alternatively, in an instance in which the processor is configured to connect to a WLAN 12 which supports IMS connectivity if available, the UE may select the highest priority WLAN which supports IMS connectivity.

In an example embodiment, a user may select or configure the processor 22 to prefer a WLAN 12 which supports IMS connectivity in the WLAN selection procedure. In an instance in which the processor 22 is configured with IMS connectivity preferred the processor may prioritize and/or select a WLAN 12 as described above. In an instance in which the processor 22 is not configured with IMS connectivity preferred or a WLAN 12 which supports IMS connectivity is not available, the processor 22 may prioritize and/or select a WLAN using a prioritization procedure such as 3GPP TS 23.402.

As described above, FIG. 3 illustrates a flowchart of an apparatus 20, method, and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, such as illustrated by the dashed outline of block 306 in FIG. 3. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving, in response to an access network query, an available public land mobile network (PLMN) list; wherein the PLMN list comprises an IP multimedia subsystem access point name (IMS APN) indication for the respective PLMNs with IMS connectivity;
determining, using a processor, if a connection to a home PLMN (HPLMN) can be established using an IMS APN associated with a PLMN from the PLMN list; and
prioritizing available wireless local area networks (WLAN) based on the determining if a connection to the HPLMN can be established using the IMS APN for the respective PLMNs of the PLMN list associated with the respective WLANs.

2. The method of claim 1 further comprising:
filtering the PLMN list based on PLMNs which can establish communication with the HPLMN using the associated IMS APN.

3. The method of claim 1, wherein the PLMN list further comprises IMS APN availability information for the respective PLMNs.

4. The method of claim 3 wherein the PLMN list further comprises an IMS roaming level indication for each IMS APN.

5. The method of claim 1, wherein the PLMN list comprises an APN information code for the respective PLMNs, wherein the APN information code identifies the available service APNs.

6. The method of claim 1, wherein the PLMN list further comprises PLMN that interwork on IMS level with the respective PLMNs.

7. The method of claim 1, wherein the IMS connectivity is local break out roaming.

8. An apparatus comprising at least one processor and at least one memory including computer program code, the at least one memory and computer program code configured to, with the processor, cause the apparatus to at least:
receive, in response to an access network query, an available public land mobile network (PLMN) list; wherein the PLMN list comprises an IP multimedia subsystem access point name (IMS APN) indication for the respective PLMNs with IMS connectivity;
determine, using a processor, if a connection to a home PLMN (HPLMN) can be established using an IMS APN associated with a PLMN from the PLMN list; and
prioritize available wireless local area networks (WLAN) based on the determining if a connection to the HPLMN can be established using the IMS APN for the respective PLMNs of the PLMN list associated with the respective WLANs.

9. The apparatus of claim 8, wherein the at least one memory and the computer program code are further configured to:
filter the PLMN list based on PLMNs which can establish communication with the HPLMN using the associated IMS APN.

10. The apparatus of claim 8, wherein the PLMN list further comprises IMS APN availability information for the respective PLMNs.

11. The apparatus of claim 10, wherein the PLMN list further comprises an IMS roaming level indication for each IMS APN.

12. The apparatus of claim 8, wherein the PLMN list comprises an APN information code for the respective PLMNs, wherein the APN information code identifies the available service APNs.

13. The apparatus of claim 12, wherein the PLMN list further comprises PLMNs that interwork on an IMS level with the respective PLMNs.

14. The apparatus of claim 8, wherein the IMS connectivity is local break out roaming.

15. A computer program product comprising at least one non-transitory computer-readable storage medium having computer-executable program portions stored therein, the computer-executable program code portions comprising program code instructions configured to:
receive, in response to an access network query, an available public land mobile network (PLMN) list; wherein the PLMN list comprises an IP multimedia subsystem access point name (APN) indication for the respective PLMNs with IMS connectivity;
determine, using a processor, if a connection to a home PLMN (HPLMN) can be established using an IMS APN associated with a PLMN from the PLMN list; and
prioritize available wireless local area networks (WLAN) based on the determining if a connection to the HPLMN can be established using the IMS APN for the respective PLMNs of the PLMN list associated with the respective WLANs.

16. The computer program product of claim 15, wherein the computer-executable program code portions further comprise program code instructions configured to:
filter the PLMN list based on PLMNs which can establish communication with the HPLMN using the associated IMS APN

17. The computer program product of claim 15, PLMN list further comprises IMS APN availability information for respective PLMNs.

18. The apparatus of claim 17, wherein the PLMN list further comprises an IMS roaming level indication for each IMS APN.

19. The computer program product of claim 15, wherein the PLMN list comprises an APN information code for the respective PLMNs, wherein the APN information code identifies the available service APNs.

20. The computer program product of claim 15, wherein the PLMN list further comprises PLMNs which interwork on an IMS level with the respective PLMNs.
